(19) United States
(12) Patent Application Publication
(10) Pub. No.: US 2007/0243011 A1
(43) Pub. Date: Oct. 18, 2007

(54) Writing instrument with clip

(75) Inventor: Jean-Patrick Dalancourt, St. Etienne De Montluc (FR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Sanford GmbH, Hamburg (DE)

(21) Appl. No.: 11/709,585

(22) Filed: Feb. 22, 2007

(30) Foreign Application Priority Data
Feb. 23, 2006 (DE) 20 2006 003 064.6

(51) Int. Cl. B43K 29/00

(52) U.S. Cl. 401/195; 401/131

(57) ABSTRACT

A writing instrument with a clip, having a writing instrument part with a contact area on its outer surface having variable radii, and a clip engaging the contact area and being axially rotatable relative to the writing instrument part.

### BACKGROUND OF THE INVENTION

1. Field of the Invention

The invention relates to a writing instrument with clip. The writing instrument can be a fountain pen, a stylus, a roller ball pen, or a ball point pen, for example, and can also have a rotary mechanism for moving in and out a writing tip or nib or a lowerable/retractable writing tip or nib.

2. Related Technology

Known writing instruments are often inserted in a shirt or jacket pocket, e.g. a sports jacket pocket, and fastened with a clip. In addition, known writing instruments may also be fastened by means of the clip to a writing pad or case, or the like. Fastening takes place in such a way that the clip is forced away or lifted off and as a result an insertion opening is formed between the outer surface of the writing instrument and the clip, particularly the clip leg or head, in which can be engaged and jammed the fabric of e.g. the shirt or jacket pocket or the paper or cardboard.

Since, however, the materials, such as the shirt and jacket fabric or the paper and cardboard have different thicknesses, such writing instruments can be fastened to a varyingly satisfactory extent by means of a clip to shirt and jacket pockets, etc.

### GENERAL DESCRIPTION OF THE INVENTION

The invention increases the security of the fastening of a writing instrument with clip.

The invention provides a writing instrument with a clip, when the clip is axially rotatable relative to a writing instrument part, on which the clip engages, and the outer surface of the writing instrument part, at least in the clip contact area, has a radial cross-section with gradually or continuously variable radii. The relative movement results from either the clip or the writing instrument part being axially rotatable.

It can in particular be provided that the writing instrument part is a first housing part. For example, the first housing part can be a head part of the writing instrument.

It is also possible for the clip to be located on a second housing part. It is alternatively conceivable for the clip to be located on the rotary cap or on a rotary button.

According to a further embodiment of the invention, the clip is connected to rotate on the second housing part. The second housing part can be axially rotatable. Alternatively the first housing part can be axially rotatable.

It is also possible for the clip to be fastened to the second housing part.

Alternatively the clip can be injection molded into the second housing part. For example, the second housing part can be produced by a plastic injection molding process, in that the metal clip is injection molded in or round by a plastics material differing from the plastics material of the second housing part.

It is also possible to integrally shape the clip on the second housing part.

Preferably the clip or second housing part is rotatable by preferably 90° relative to the writing instrument part or first housing part.

Advantageously the clip can be locked in at least two rotation positions.

It can in particular be provided that the two rotation positions are two rotation positions on the outermost ends of a rotation range. If e.g. the rotation range extends over 90°, the two rotation positions can be the 0° and 90° positions.

The clip can also have a free end directed toward the writing tip or nib of the writing instrument.

It is alternatively possible for the clip to have a free end directed away from the writing tip or nib of the writing instrument.

Preferably the clip end is bent away from the writing instrument. This can facilitate the insertion and fastening of the shirt or jacket fabric or the paper, cardboard, etc.

Advantageously the clip may be mechanically pretensioned towards the writing instrument part over at least part of its rotation range.

According to another embodiment of the invention the outer surface of the writing instrument part has an oval cross-section, at least in the clip contact area.

The clip can also be made from metal.

Alternatively the clip can be made from plastic.

Preferably the writing instrument part is made from plastic.

It is alternatively possible for the writing instrument part to be made from metal.

The invention is based on the surprising finding that through the axially rotatable design of the clip and the design of the outer surface of the writing instrument part, at least in the clip contact area, with a radial cross-section having gradually or continuously variable radii, the width of the insertion opening is increased in the radial direction or the clip pretension can be adjusted in planned manner, so that the writing instrument with clip can be securely fastened to materials, such as e.g. shirt or jacket fabric, etc. having different thicknesses. To this end the clip is axially rotatable in adjustable or planned manner.

### BRIEF DESCRIPTION OF THE DRAWING

Further features and advantages of the invention can be gathered from the claims and the following description relative to an embodiment and the attached diagrammatic drawings, wherein show:

FIG. 1 is a view of a writing instrument according to one embodiment of the invention, shown from the side.

FIG. 2 is a view of the writing instrument of FIG. 1, from the right in the latter.

FIG. 3 is a view, like FIG. 1, but in which a first housing part is axially rotated by 90° relative to the first housing part in FIG. 1.

FIG. 4 is a view of the writing instrument of FIG. 3, from the right of the latter.

FIG. 5 shows various views of a clip of the writing instrument of FIGS. 1 to 4, in which FIG. 5a is a view from the side, FIG. 5b is a view from above, FIG. 5c is a view from below, FIG. 5d is a view from the right, and FIG. 5e is a view from the left in FIG. 5a.

FIG. 6 is an axial sectional view of the writing instrument of FIG. 1.

FIG. 7 is a sectional view along line VII-VII in FIG. 6.

FIG. 8 shows various views of the first housing part, FIG. 8a being an axial sectional view, FIG. 8b being a view from above, and FIG. 8c being a sectional view along line VIII-VIII of FIG. 8a.

FIG. 9 shows various views of a second housing part, FIG. 9a being a view from the side, FIG. 9b being an axial sectional view, and FIG. 9c being a view from the right in FIG. 9a.

### DETAILED DESCRIPTION

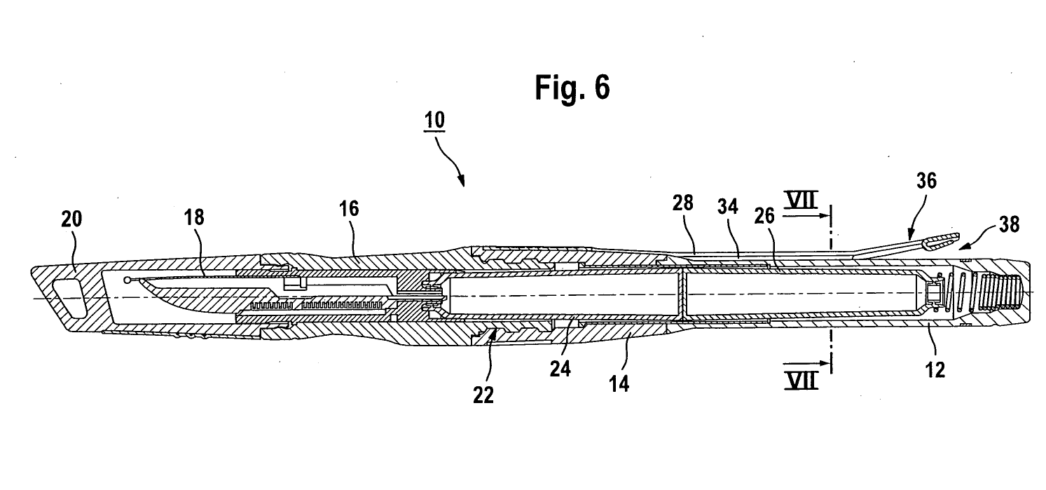

The writing instrument 10 shown in the drawings is a fountain pen, which inter alia comprises a first housing part 12 at the rear end of writing instrument 10, a second housing part 14 connecting onto the same, a third housing part 16 connected thereto and in which is located the fountain pen nib 18, and a cap 20 for covering the nib 18. The first housing part 12 is in axially rotatable connection with the second housing part 14. The second housing part 14 is connected by means of a screw connection 22 (FIG. 6) to the third housing part 16. Two ink cartridges 24 and 26 (FIG. 6) can be placed in the cavity formed by the first and second housing parts 12, 14.

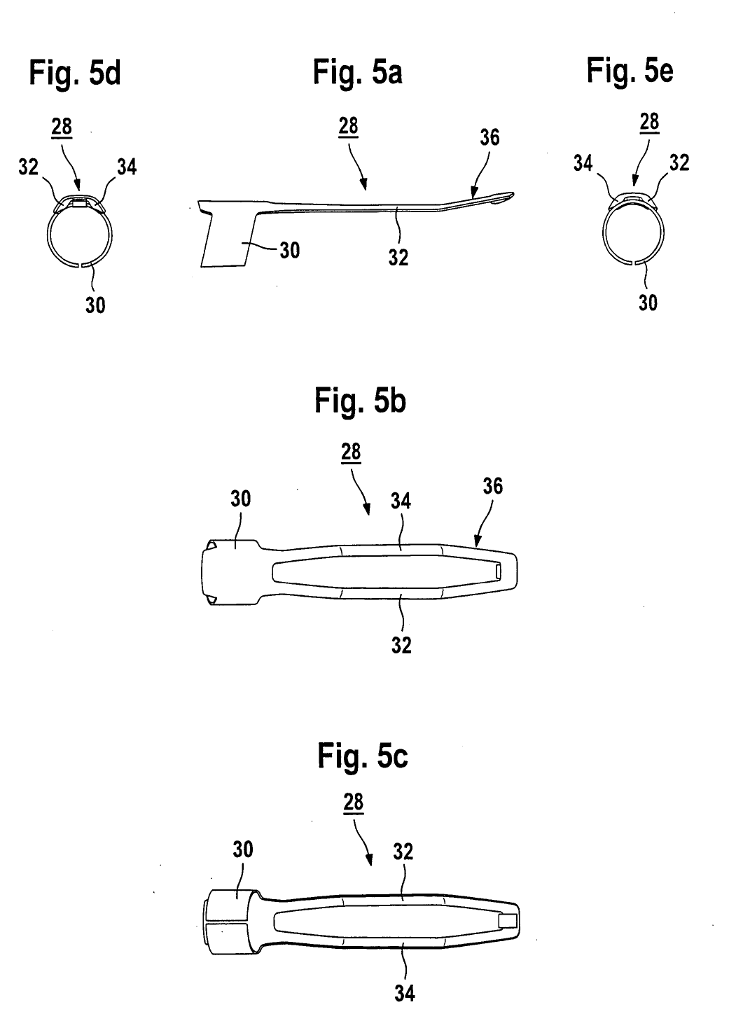

Onto the second housing part 14 is fastened a clip 28, which comprises an almost closed ring 30 and two clip legs 32, 34 extending therefrom in substantially parallel manner to the central axis of the ring, said clip legs 32, 34 being joined at their free ends (FIGS. 5a to 5d). The clip legs 32, 34 form a leg with a free end 36 bent away from the first housing part 12. The clip leg resulting from the two clip legs 32, 34 is not mechanically pretensioned toward the first housing part 12 in this angular position. The insertion of a fabric e.g. forming a shirt or sports jacket pocket through an insertion opening 38 is facilitated by the bent away, free end 36.

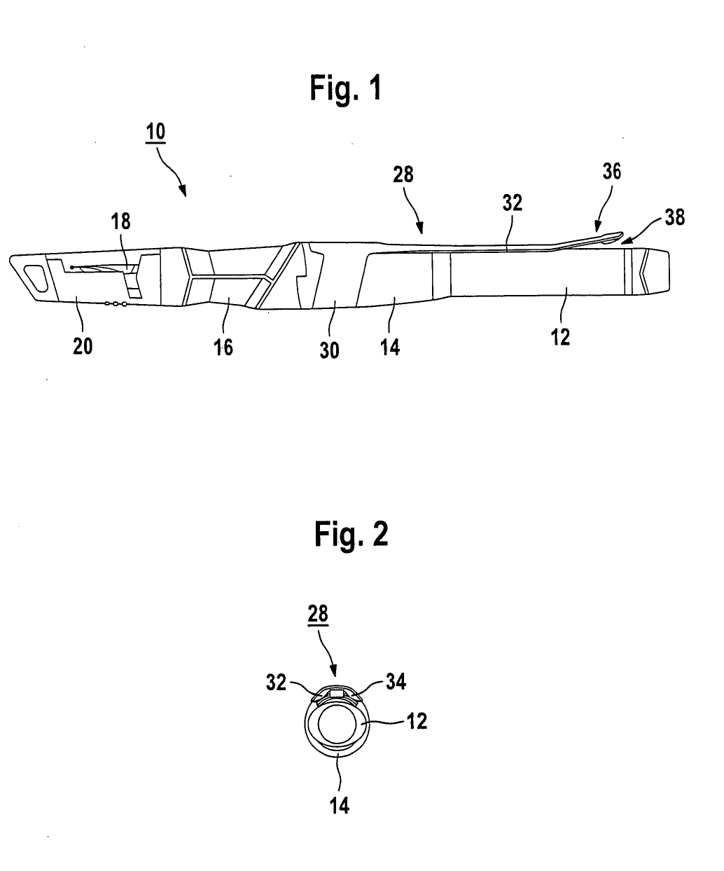

As can be gathered from FIG. 1, the clip 28 or the clip leg formed by the clip legs 32, 34 is remote from the writing tip, in the present case the nib 18.

FIG. 2 shows an outer surface of the first housing part 12 having an oval cross-section.

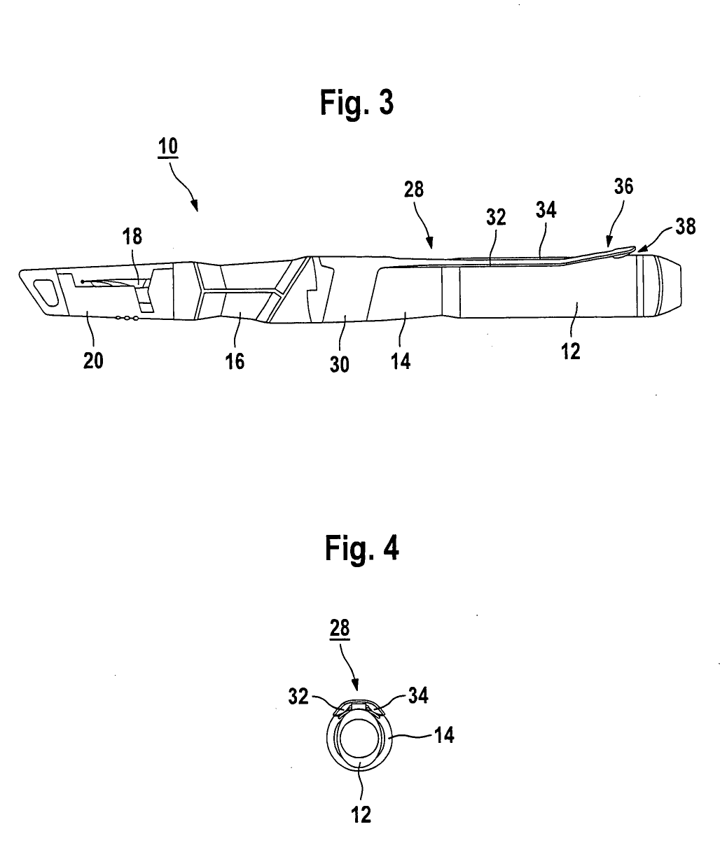

In FIG. 3 the first housing part 12 is axially rotated by 90° relative to the first housing part 12 and therefore the second housing part 14 in FIG. 1. This can be gathered from FIG. 4. As a result of this rotation the insertion opening 38 has become radially narrower and the clip leg formed by clip legs 32, 34 has a mechanical pretension against the first housing part 12. As a result the clip 28 can be better or more securely fastened to thinner materials.

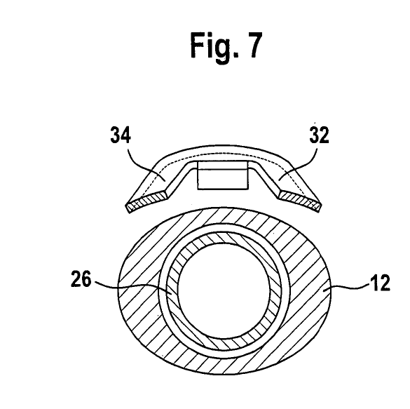

As can be gathered from FIG. 7, the clip leg formed from clip legs 32 and 34 with the first housing part 12 in the angular position shown in FIGS. 1, 2 and 6 does not engage on the first housing part 12. This only takes place when the first housing part 12 is axially rotated by 90°, as shown in FIGS. 3 and 4.

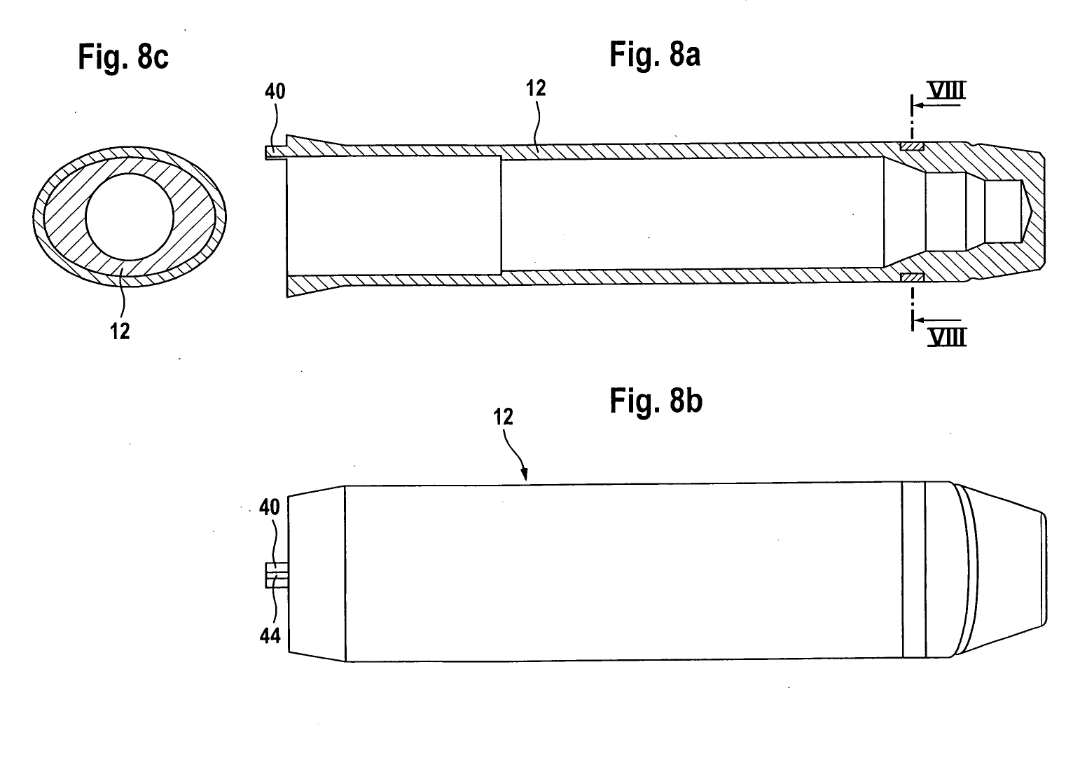

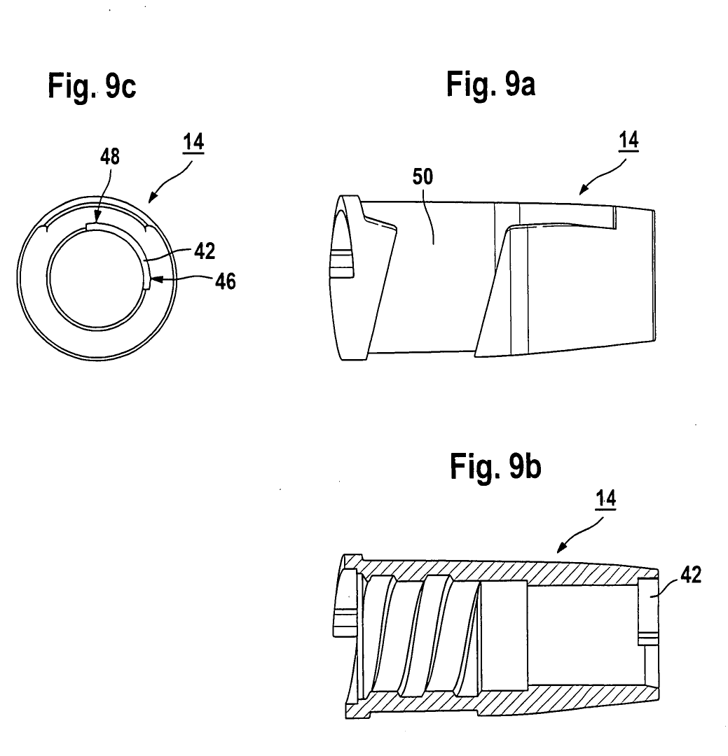

As is apparent from FIGS. 8a and 8b, the first housing part 12 is provided on an edge directed towards the second housing part 14 with a stud 40, which moves or is guided in a substantially quadrantal groove 42 in the edge of the second housing part 14 directed toward the first housing part 12 (FIGS. 9b and 9c). Therefore the rotation range of the first housing part 12 is limited to an angle of approximately 90°. A web 44 on stud 40 in the outermost rotation positions (0° and 90°) engages in notches 46, 48 respectively in the quadrantal groove 42.

As can also be gathered from FIG. 9a, the outer surface of the second housing part 14 has a depression 50 such that the ring 30 of clip 28 is received therein, substantially without radially projecting over the second housing part 14.

The features of the invention disclosed in the description, drawings and claims can be individually or in random combinations essential to the implementation of the different embodiments of the invention.

1. (canceled)

2. Writing instrument according to claim 20, wherein the writing instrument part is a first housing part.

3. Writing instrument according to claim 20, wherein the clip is located on a second housing part.

4. Writing instrument according to claim 3, wherein the clip is connected to rotate on the second housing part.

5. Writing instrument according to claim 4, wherein the clip is fastened to the second housing part.

6. Writing instrument according to claim 4, wherein the clip is injection molded in the second housing part.

7. Writing instrument according to claim 4, wherein the clip is integrally shaped onto the second housing part.

8. Writing instrument (10) according to claim 3, wherein the clip or second housing part is rotatable relative to the writing instrument part or the first housing part.

9. Writing instrument according to claim 20, wherein the clip can be locked in at least two rotation positions.

10. Writing instrument according to claim 9, wherein the two rotation positions are two rotation positions at the outermost ends of a rotation range.

11. Writing instrument according to claim 20, wherein the clip has a free end directed towards toward a writing tip of writing instrument.

12. Writing instrument according to claim 20, wherein the clip has a free end directed away from a writing tip of writing instrument.

13. Writing instrument according to claim 11, wherein the free end of the clip is bent away from writing instrument.

14. Writing instrument according to claim 20, wherein, at least over part of its rotation range, the clip is mechanically pretensioned toward the writing instrument part.

15. Writing instrument according to claim 20, wherein, at least in the contact area of clip, the outer surface of the writing instrument part has an oval cross-section.

16. Writing instrument according to claim 20, wherein the clip is made from metal.

17. Writing instrument according to claim 20, wherein the clip is made from plastic.

18. Writing instrument according to claim 20, wherein the writing instrument part is made from plastic.

19. Writing instrument according to claim 20, wherein the writing instrument part is made from metal.

20. Writing instrument, comprising:
a) a writing instrument part comprising an outer surface having at least in a contact area of the outer surface a radial cross-section with gradually or contiuously variable radii; and,
b) a clip engaging said contact area of the outer surface and being axially rotatable relative to said writing instrument part.

21. Writing instrument according to claim 8, wherein the clip or second housing part is rotatable by 90° relative to the writing instrument part of the first housing part.

22. Writing instrument according to claim 12, wherein the free end of the clip is bent away from writing instrument.
